(19) United States
(12) Patent Application Publication
(10) Pub. No.: US 2015/0363890 A1
(43) Pub. Date: Dec. 17, 2015

(54) ACCOUNTING SYSTEM, COMPUTER READABLE MEDIA, AND METHODS

(71) Applicant: Kenandy Inc., Redwood City, CA (US)

(72) Inventors: Rodney Butters, Larkspur, CA (US); Supriya Kaledhonkar, Fremont, CA (US)

(21) Appl. No.: 14/741,408

(22) Filed: Jun. 16, 2015

Related U.S. Application Data
(60) Provisional application No. 62/012,951, filed on Jun. 16, 2014.

(51) Int. Cl. G06Q 40/00

(52) U.S. Cl. CPC G06Q 40/12

(57) ABSTRACT

Accounting systems computer readable media and methods may generate and/or update a general ledger as source data is received. In some circumstances, source data may be received by a computer system. The source data may include information regarding a financial transaction and may be associated with one or more characteristics. A sub-ledger may be selected from a plurality of sub-ledgers, into which the source data is added responsively to one or more characteristics of the source data. Each of the sub-ledgers may include a different subset of information included in a general ledger. The general ledger may then be updated with the sub-ledger information and the updated general ledger may be provided to a user of the computer system.

### RELATED APPLICATION

This application is NON-PROVISIONAL of U.S. Provisional Patent Application No. 62/012,951 entitled “Accounting System, Computer Readable Media, And Methods” filed on 16 Jun. 2014, which is incorporated herein by reference.

### FIELD OF INVENTION

The present invention relates to an accounting system, accounting methods, and computer readable media with instructions for execution by the accounting system stored thereon.

### BACKGROUND

A common challenge for companies as well as other enterprises (collectively referred to herein as “a company”) is obtaining real-time visibility into their day-to-day financial results. Traditional financial systems have multiple separate tables for general ledger accounting entries and sub-ledger entries relating to financial transactions for the company (e.g., payables, receivables, asset depreciation, etc.) Traditionally, managed processes perform calculations at the sub-ledger level and then move these calculations from sub-ledger tables to the general ledger, either as individual entries or as consolidated balances. The process of moving data from these separate tables into the general ledger table results in a lag or delay in visibility of financial results caused by the lag time for entries to post to the general ledger from the separate sub-ledgers and tables.

A second challenge is that the movement of information between these sub-ledgers and tables must be coordinated through a complex series of processes governed by a complex and changing set of rules. The timing and sequence of these processes impacts the accounting results and any errors in these processes will result in incorrect accounting information. Also, because the results are dependent on the sequence of these processes, the results are not repeatable by exactly replicating the sequence of steps. Therefore when errors occur in execution of these processes or omissions of critical data in the source accounting data are found, complex and costly processes are required to enter the corrections and then apply the update process to propagate correct information to the general ledger table.

Additionally, a common challenge for companies, particularly in regulated industries, is full lifecycle tracking in a single system for costing and accounting; the ability to locate and follow a material's or document's history from its origin, through material supply chain, the manufacturing process, to the point of shipment to a customer. Traditional accounting software systems have separate systems, with separate data models and tables including various components of their operation related to, for example, managerial accounting, supply chain planning, material supply, production planning, manufacturing execution, production history or genealogy, and fulfillment. In order to move a product through the lifecycle from planning to fulfillment and capture all the costing and accounting information, these systems require information to be transferred from one system to the next as material progresses through the lifecycle. Transfer of data can happen either through integration points that need to be maintained or through manual re-entry of data. This transfer can cause errors as well as delays.

### SUMMARY

Accounting systems, computer readable media, and methods are herein described. According to one embodiment, executed by a computer system, source data may be received by a computer system. The source data may include information regarding a financial transaction and may be associated with one or more characteristics, such as, but not limited to, a date, a source, a product, and a financial amount. In some embodiments, the source data is received from a plurality of sources.

Then, a sub-ledger, which represents a logical grouping of source documents and their accounting, may be selected from a plurality of sub-ledgers, into which the source data is accounted. The selection may be responsive to one or more characteristics of the source data and each of the sub-ledgers, which again represents a logical grouping of accounting entries and may include a different subset of information to be included in these accounting entries in the general ledger. These sub-ledger subsets of the general ledger may then be updated with the related source document information and the updated general ledger may be provided to a user. In some circumstances, the general ledger may be compliant with one or more governmental regulations. In some embodiments, the general ledger may be dynamically updated as the source data is received on an as-needed basis.

In some embodiments, the general ledger may be validated on, or following, a closing date of a time period associated with the general ledger and, following the validation, the general ledger may be finalized such that the information included in the general ledger pertaining to the time period cannot be changed. In circumstances where the source data is associated with a finalization date and the sub-ledger is associated with a cutoff date, the validation may be performed using source data with a finalization date occurring on, or after, the general ledger closing date and sub-ledger information with a cutoff date occurring on, or after, the general ledger closing date.

In some embodiments, the general ledger may be dynamically updated prior to a closing date of the general ledger. Additionally, or alternatively, the source data may include financial information about a projected financial transaction.

In one embodiment, an instruction to delete the source data from the sub-ledger may be received and the source data may be deleted from the sub-ledger accordingly. This then updates these sub-ledger entries directly from general ledger.

In some circumstances, where the source data is finalized, an instruction to adjust the source data may be received and the associated entry for the sub-ledger in the general ledger will be generated responsively to the received instruction.

In another embodiment, an open transaction may be identified and it may be determined whether a transaction date of the open transaction is prior to a period end date for a general ledge and, if so, the open transaction may be recognized as being associated with a current period of the general ledger. For purposes of determining the association of a source document transaction with the period, the transaction is associated with a sub-ledger. It may then be determined whether a finalization date of the open transaction is prior to that sub-ledger's closing date and an accounting entry is created for the open transaction in the appropriate period. The accounting entry may include the transaction date as a date within the general ledger. The accounting entry may then be posted to the general ledger and the general ledger may be provided to a user of the computer system.

In one embodiment, a reversing journal entry accrual may be generated using the period end date as the general ledger date responsively to a determination that a final date for an open transaction is after a sub-ledger closing date and posted to the general ledger in the current period. In some instances, the journal entry accrual may be reversed on the first day of the next period. In some circumstances, another accounting entry may be created using a finalization date of the open transaction as a general ledger date responsively to a determination that the finalization date for the open transaction is prior to a sub-ledger closing date for the second period. The other accounting entry may then be posted to the general ledger in the second period.

In another embodiment, a reversing journal entry accrual may be generated in the current period using the period end date as the general ledger date responsively to a determination that a transaction date for the transaction is after the sub-ledger closing date. The reversing journal entry accrual may then be posted to the general ledger in the current period.

### BRIEF DESCRIPTION OF THE DRAWINGS

The present application is illustrated by way of example, and not limitation, in the figures of the accompanying drawings, in which:

FIG. 1 depicts an exemplary system, consistent with some embodiments of the present invention; and

FIGS. 2-6 depict flowcharts illustrating the steps of exemplary processes, consistent with some embodiments of the present invention.

Throughout the drawings, the same reference numerals and characters, unless otherwise stated, are used to denote like features, elements, support structures, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

The present invention is designed as a system with one material transaction data model to track source documents throughout the entire lifecycle. From draft to final material event the system and processes described herein use one data model to track source documents and their data through their lifecycle to completion. The source documents follow a once and done model: they execute their lifecycle exactly once from draft to material event.

The accounting system discussed herein is configured to provide a real-time general ledger that provides near real-time updates of the trail balance of a general ledger and associated financial statements and managerial reports. The accounting system provides a classification of the general ledger into full suite of logical sub-ledgers. As a general note, all dates disclosed herein dates are associated with a date stamp, a time stamp, or both and may be based on a set time zone (e.g., Greenwich Mean Time (GMT)) and stored in UTC format. In this way, the dates can accommodate and be accurately recognized by companies or enterprises with operations in multiple time zones. Most date and time ranges discussed herein signal a closed interval at the start date and an open interval on the end date.

Often times, the accounting system is implemented using a distributed computer network and may be Internet enabled. In some embodiments, the accounting system is a hosted or a cloud computer network based and may be built on a multitenant cloud computing architecture, which may bear a resemblance to a client-server or other distributed computing architecture. The data and processes of the present invention may be stored and managed in wide range of records encompassing the entire data lifecycle, referred to as wide-body objects. The presently described processes have application to deployment on any type of infrastructure that utilizes objects, tables, or files for storage of data. In the present description, objects may be referred to as tables.

The present systems and methods use a limited number of tables to store the source documents and generate a general ledger including, but not limited to:
A single material table representing a quantity of material in a particular state including forecast, plan, allocated, issued, or history;
A single pair of material transaction tables (header table and lines table) representing a logistics, production, services or entitlement operation recorded or driven by a source document;
A set of pairs of business operational document tables (header table and lines table) representing source documents for sales and production orders, purchases, shipments, receipt of material, work orders, invoices, payments and cash receipts
Material records tables that have a relationship to material transaction records that are used to represent any material operation. These tables may capture the receipt of materials at various stages of a transaction from forecast or plan to inventory, the movement of materials, the composition or decomposition of materials in production, and the transition of finished goods or by-products to shipments throughout planning, execution and fulfillment lifecycle stages; and
The material and material transaction tables represent material throughout the transaction lifecycle from plan to production to fulfillment. Thus, the same records that represent the execution plan may become the history information, meaning they closely, and in some cases, exactly capture complete product genealogy and traceability.

By comparison, traditional ERP systems are implemented with thousands of tables to capture an equivalent amount of information. As a result, information gets copied through multiple layers of software from table to separate table based on the software module managing a particular step in the material lifecycle again causing errors and delays and complexity in analysis and reporting.

The present system and methods provide the benefit of no loss of history or traceability details. This makes the results easier to verify and validate. The present system and methods do not require integration points to be maintained for continuity in the material transaction lifecycle or manual re-entry of data between systems, thereby making them more accurate as well as easier and more efficient to run with real-time visibility into the financial data. Furthermore, the present system and methods provide real-time visibility into detailed transaction history for the purpose of complying with government regulations, supporting audit within a period and after period close, and support for what-if and comparative scenarios of operations and results.

Exemplary applications for the present accounting system and methods include automated accounting for order-to-cash, procure-to-pay, planning & production, and global financials for companies that manufacture, distribute or design products, also known as “product” companies. However, the concepts described herein also have applicability to financial analysis and accounting for all types of companies in both the product and services sector or companies engaged in subscription, rental and other periodic pay per service models and the provisioning of such services.

The present invention generates accounting entries that are placed directly into the general ledger based on business source documents and accounting source documents, their transaction dates and pre-defined accounting rules. The general ledger includes two types of tables: a general ledger entry lines table containing all the debits and credits associated with a single general ledger entry, and a general ledger entry header table whose rows are referenced by the collection of lines making up a single logical general ledger entry. No other tables are used for the general ledger. Business source documents do not post first to a separate sub-ledger table representing the accounting information for a functional area, but post directly to the general ledger table. Accounting source documents (referred to as Journal Entries) are managed as only two tables, again header and lines tables, for all accounting supplied information. No additional tables are used to transfer information between the source documents and general ledger entries. This process of using a limited number of tables for operation is different from the process used by ERP and financial accounting systems, which rely on entries from a sub-ledger to populate the general ledger.

The generation of general ledger entries from business source documents and accounting source documents is directed by a set of rules that define a number of factors including: 1) how a business source document is translated into (a) a set of debits and credits for accounting purposes and/or (b) a set of financial measures for managerial and cost accounting purposes, 2) how business source documents in an accounting period relate to the end period date, a sub-ledger close date, a period close date, the business source documents' dates for creation, finalization, and material business operational events, and 3) how accounting source documents are included in an accounting period again relative to the same set of dates.

The present invention provides the following exemplary benefits.
There is no delay or manual intervention in posting accounting entries to the general ledger. The accounting entries can be automatically generated, based on the pre-defined accounting rules, and are available for review when transactions related to the account entry occur.
The generation of accounting entries for inclusion in the general ledger can be completely decoupled from the generation and finalization of other business and accounting source documents. This allows for the generation of the general ledger entries that are completely execution process independent and, as a result, when a process is run the same results will be generated regardless of when the generation of general ledger entries occurs.
The generation of general ledger entries is completely rerunable. Thus, the generation of general ledger entries can be run multiple times and will always generate the same results for the same set of source documents regardless of when the generation of the source documents occurs. This allows for separate validation of the general ledger entries for audit purposes.
The business sequence of general ledger entries can be generated, replayed and validated allowing for auditing of all financials information changes associated with the business and accounting activity associated with the financial close process from sub-ledger close to final period close accounting results. The execution of the generation of general ledger entries is completely independent of the business and accounting processes associated with the financial close. A snapshot of an aged trial balance can be provided to audit at any time during an open period, after sub-ledger close or after period close, and a complete sequence of all business and accounting changes resulting in additional general ledger entries can be generated at any time without depending on when the generation of general ledger entries occurred. No sequence of steps is required in the generation process.
The general ledger entries contain direct references to the business and accounting source documents from which they were generated, allowing for direct tracking of the source information to accounting information for analysis, audit and verification of corporate compliance. No intermediate tables appear between the general ledger entries and the source documents.
Period and sub-ledger close dates and accounting rules that generate the general ledger entries from the source documents will generate the same information regardless of when the posting to the general ledger is executed, such that the generation of the general ledger is repayable, repeatable and verifiable at any point in time.

The accounting rules utilize additional information to generate general ledger entries. This information includes, but is not limited to cost information for raw materials, labor, equipment, facilities, utilities and all other potential costs including standard costs and cost variances and/or actual costs; master data information on customers, suppliers, and other operating units of the business; and revenue recognition information such as pricing, standard and average discounting, and other forms of pricing, contract and discount information needed for recognizing both standard and multi-part transactions.

In addition to the generation of general ledger entries, the processes described herein also provide the capability to perform a what-if or trial type analysis on the financial results without disturbing the overall general ledger. Additionally, accounting rules and additional information used for generation of general ledger entries can be revised and used to generate a view of alternative financial results. This information can be used for comparative and budgetary analysis.

A general ledger is an overall balance sheet for the accounting of financial transactions for a company, entity, or sub-entity generated by an accounting system. General ledgers may act as a centralized repository for a company's accounting records. Accounting entries in the general ledger may be generated or regenerated at any time during an open period from, for example, source documents, journal entries, accounting rules, segments objects, costs, reference data, or some combination thereof. The accounting system and/or an accounting rules engine generate the accounting entries. Accounting entries may be entered or “posted” to a general ledger when the accounting entry is generated without any exceptions or warnings and an entered or posted accounting entry is a logical result of generating an accounting entry in a period with no exceptions reported. Accounting entries are generated from source documents and/or journal entries and posted to the general ledger as well as classified by sub-ledgers, reports, or dashboards as a one-step process executed by the accounting system and/or accounting rules engine. The accounting entries may be generated in one or more asynchronous processes (when the source document and/or journal entry is finalized through an automated asynchronous process) or synchronously on demand (when the source document and/or journal entry is finalized synchronously through an interactive step).

Accounting entries may be deleted or obsoleted from a general ledger (depending on the data controls and retention policies selected by the user) and recreated without causing any errors or omissions in the overall accounting results for the general ledger. In this way, one or more accounting processes associated with the general ledger can be replayed or rerun through the accounting rules engine and create any and all missing accounting entries for any open period without user intervention.

The general ledger date (i.e., date on which an accounting entry may be entered in the general ledger) for a particular accounting entry is generated based on the source document transaction date and/or journal entry and the finalization date, and the sub-ledger cutoff date for the relevant period. The general ledger date assigned to an accounting entry is determined based on the transaction date and finalization date for the source document and/or journal entry.

An accounting entry will have a creation date, which will correspond to a date the accounting entry was opened or created. The creation date is not related to the general ledger date and does not affect the accounting results of the general ledger or indicate a chronology of generating accounting information because a creation date does not indicate that the accounting entry has been finalized.

A period corresponds to a segment or duration of time within which all general ledger entries for a particular period must be made. A period start date and a period end or cutoff date mark the duration of a period. A duration of a period is user configurable or set by default. After a period closes, accounting entries within the general ledger or underlying source documents or journal entries cannot be directly modified. Furthermore, no source documents or journal entries can be entered into the general ledger for the closed period.

In all instances, when a period is closed, accounting entries of the period are locked and can't be modified or regenerated. Locking accounting entries following a period close acts to protect against any changes to accounting rules or other generation data that may be changed following the period close that may affect the calculation of the accounting entries or the general ledger. Following the period close date, the accounting entries of the period become the permanent record for the period. In this way, the accounting system does not rely on effective dates, versioning, or histories for the accounting rules and all related source data for the generation of the general ledger or sub-ledgers.

Additionally, following a period and/or sub-ledger cutoff, the general ledger and sub-ledger results for the period and/or sub-ledger may be validated. Validation acts to ensure that all the data values resulting from the accounting entry generation process are permanently captured. After validation and period close, the accounting rules and reference data are free to change for application to the next period or any period thereafter. Additionally, comparative reports showing what the current accounting rules would generate for a closed period may be generated in, for example, a what-if type of scenario.

Source documents are documents or data sets that include information regarding a transaction or economic activity at the company or entity for whom the general ledger is being prepared including, but not limited to, cash and/or inventory transactions, invoices, payments, and receipts. For accounting of source documents, the accounting rules define exactly the facts used for general ledger accounting entry generation.

A source document may be finalized once the transaction/economic activity associated with the source document is complete. Finalization of a source document indicates that the source document contains material information for an economic event contributing to the financial results of the general ledger and/or company and cannot be further changed without appropriate controls. These controls allow for changes to be made to a finalized source document as explained below. Once a source document is finalized, it is managed by the accounting system to prevent further material change. However, in certain circumstances under appropriate controls, a source document may be unfinalized, modified, and then re-finalized.

The source document is finalized at the “finalization date.” The finalization date for a particular accounting entry occurs when a source document associated with the accounting entry is finalized. The finalization date corresponds to the effective posting date for the accounting entry. The effective posting date is the date upon which the accounting entry is posted to the general ledger. The finalization date may be used to generate an audit log, which may be used to, for example, establish a transactional chronology for audit purposes and/or generate a timeline of any changes in the trial balance from period end to period close. If the finalization date of a source document occurs within a period different from the transaction date (discussed below), a notice or warning may be associated with an accounting entry associated with the source document.

Finalization of the source document means the transaction/economic activity of the source document is material (e.g., drives accounting and financial results), is auditable (e.g., evidence or authorized signoff it occurred), and permanent (cannot be reversed, but instead must be voided to back out leaving an audit trail). Once a source document is finalized, information from the source document may be analyzed by the accounting system and entered into the general ledger as an accounting entry. Also, once a source document is marked finalized, material data in the source document cannot be modified further by the system or by users as enforced by, for example, one or more protocols or rules executed by the accounting system.

The finalization date determines the earliest period an accounting entry associated with a finalized source document can be assigned to, based on the period start and end dates. The later (greater) of these two dates (transaction date and period start date) that an accounting entry can be assigned to corresponds to the general ledger date.

A finalized source document can be unfinalized any time before the sub-ledger cutoff date. When it is unfinalized, the accounting entry generated in the general ledger for the finalized source document is marked obsolete. When the unfinalized source document is again finalized, a new accounting entry will be added to the general ledger. Additionally, the accounting entries generated for any journal entries related to the unfinalized source document may be deleted as well.

Source documents can be unfinalized after the sub-ledger cutoff date, if the period is still open and their accounting entry is marked obsolete. However, if a source document is deemed material by the business process and formally needs to be modified after the sub-ledger cutoff date, it must be voided first. The accounting entry associated with the voided source document is also voided, generating an additional reversing accounting entry. The source document may then be cloned and a new accounting entry may be generated and added to the general ledger.

When a source document is for a single company or enterprise, the source document may be used to generate a single accounting entry for the company. When the source document is for multiple parties within a company, as may be the case with an intercompany transaction, the source document may generate two accounting entries for inclusion in the general ledger within a single general ledger period; one for each party to the transaction.

On occasion, source documents for intercompany transactions may have a statutory transaction date to accommodate separate economic events for local accounting standards of an intercompany source document. When a statutory transaction date is present, the source document can generate an additional two accounting entries, one for each company, both with the same general ledger date and period, but in this case the accounting rule may post the adjustment accounting entry for the transaction. In some instances, intercompany source documents may be governed by a global sub-ledger cutoff date that applies to all intercompany transactions and period transfer pricing transactions. This potentially requires separate cutoffs for the transactional activity and the period transfer activity however, both will generate intercompany accounting entries.

A journal entry is a set of data that specifies accounting sourced information, which is typically provided by the accounting department of a company or enterprise. Journal entries generate a single accounting entry for the company for a period. At times, a journal entry may generate accounting entries in multiple periods. For example, two accounting entries may be generated within two different periods for an accrual event (accrual and reversal) or when one or more periods are needed for revenue recognition (moving bookings to revenue or expense). In some instances, journal entries may relate to intercompany transactions and, in this case, the journal entry will create accounting entries for both companies. Accounting entries for journal entries can be generated asynchronously for each open period for each company.

Journal entries have a transaction date and finalization date. The timing of when journal entries are entered into the general ledger is governed by the period cutoff date. If the finalization date of the journal entry occurs after the period close date for the journal entry, a warning or exception to the journal entry may be associated with the accounting entry or journal entry.

Typically, journal entries are used to add accounting department information to the accounting system and/or accounting rules engine. Exemplary types of journal entries are a manual journal entry and an adjustment journal entry. Manual journal entries may include manually entered accounting information such as costs, receivables and/or accruables and other entries that need to flow to the general ledger. Manual journal entries may be made on a one time, as needed, or recurring basis to indicate, for example, a miscellaneous charge, accrual, or allocation to be included in general ledger as an accounting entry. In some embodiments, a manual journal entry may be used in place of default accounting entries and/or manual accounting entries. Exemplary manual and/or adjustment journal entries include a header and, at times, additional or optional lines of information.

Manual journal entries may be used to make adjustments to the accounting entries generated from the source documents through the accounting engine. Additionally, manual journal entries may be used to make adjustments, such as reclassifying revenue and expenses, accruing for one or more source documents in a different period, or distributing revenue and expenses across a number of accounts, sub-ledgers, or periods.

Journal entries are finalized as part of their lifecycle before being posted or entered into the general ledger through accounting entry generation. Accounting entries are generated for journal entries even when there is an exception on the journal entry to enable a user to see all the exceptions. Adjustment journal entries may be associated with, for example, one or more lines of the journal entry or to the entire journal entry when the a reclassified debit or credit is greater than the initial amount assigned to an account. The generated accounting entries may have exceptions when segments of the source documents and/or journal entries or adjustment entries are disallowed segment combinations. Various controls on or rules applied to source documents manage the process of clearing the accounting entries when required.

Often times, a journal entry generates a single accounting entry for the general ledger within a period. In some instances, however, a journal entry may generate multiple accounting entries in multiple periods when a journal entry is related to a single transaction or economic event that spans two or more periods, as in the case of an accrual, amortization of an asset, and/or accounting for an accrual and subsequent reversal of the accrual or revenue recognition. In some instances, accounting entries applied to multiple periods as bookings convert to revenue on the general ledger.

A transaction date for a source document and/or journal entry corresponds to the day and/or time when an economic event occurs. In some embodiments, workflow rules or process automation may be responsible for setting the transaction date from the appropriate date information in the source document. Exemplary economic events include placement of an order for goods or services, receipt of invoice, and sending or receiving a shipment of inventory. The transaction date is used to identify the period in which a transaction is to be recognized. A transaction may be recognized by a generated accounting entry. The general ledger date for an accounting entry generated from a journal entry is determined using the transaction date (which may only be a transaction period).

The general ledger date and period may be assigned to an accounting entry based on the transaction date, but only if the finalization date is before the sub-ledger cutoff for a source document underlying the accounting entry. If the source document misses the cutoff (i.e., the finalization date on or after the sub-ledger cutoff) the finalization date is used to determine the general ledger date and period for the accounting entry. At times, accounting entry generation source documents may be filtered based on their finalization date. Generally, only the source documents with a finalization date after the last closed period and sub-ledger cutoff date are considered for accounting entry generation. This ensures that the accounting entry generation for the general ledger doesn't need to go back to the beginning of the period for evaluating source documents, which is a significant performance optimization. Furthermore, the accounting entries can be searched based on finalization date, which may act to capture source documents that may have a relatively old transaction date. As a result, the finalization date for an accounting entry is generally required to be within the same period as the transaction date. Source documents may be finalized, but if they are finalized (in time) before the transaction date, the finalization date must be within the same period as the transaction date. While this may be technically required to support accounting entry generation optimization, it also makes sense from an accounting standpoint given that the document cannot be material before its transaction date and hence doesn't need to be finalized before then.

The finalization date can be as early as the start of the period within which the transaction date occurs. This allows the source document to be accounted for in a trial balance of a period as soon as it has been finalized and prior to the close of the period. In one example, an invoice may be received with a future date for being due within a particular period, yet it may be desirable for the invoice to be included in the trial balance as soon as it is received. The invoice may be finalized within the period in which it is received and accounted for early in the trial balance. This will not cause any audit change log issues because the accounting entry will be time stamped by the creation date and appear in the audit log at the proper time in the period. The general ledger date isn't copied back to the source document—the general ledger date is assigned independently by the accounting engine and doesn't require an update to the source document.

Adjustment journal entries may be made to adjust information included within a finalized source document by, for example, by accruing for the source document in a different period, reclassifying the source document to another strategic chart of accounts (“SCOA”), or distributing the source document across multiple SCOAs.

If a source document has a general ledger date that occurs in a future (unopened) period, then a warning or notice may be associated with the source document or a future general ledger date. Typically, the transaction date for an accounting entry occurs within the same period as the finalization date for the accounting entry. However, if the transaction date for an accounting entry occurs within a different period from the finalization date, the accounting entry may be associated with a warning or notice indicating the discrepancy. The transaction date sets the target period and general ledger date for an accounting entry. On occasion, operational documents may have other dates associated with them that may be relevant to general ledger entries based on accounting policies for the material event. For example, supplier invoices may be accrued on the date received. These dates may be used for setting the general ledger date by assigning the value to the transaction date subject to customization through workflow rules stored in the system.

An adjustment journal entry may be used to adjust a journal entry, source document, and/or account entry. An adjusted journal entry may be used to, for example, accrue for a finalized source document or journal entry in a period other than the period to which it was originally assigned. The adjustment journal entry may also be used to override the general ledger date for the journal entry. Adjusting a journal entry results in two accounting entries for the general ledger; one to reverse the original accounting entry of the source document from the period in which it falls, the other to accrue the accounting entry in a new period. Adjusting journal entries may generate an exception if the journal entry attempts to accrue for the source document in a period after the period has closed.

Adjustment journal entries may be used to reclassify a source document by, for example, supplying a SCOA for one side of the transaction for all lines. Adjustment journal entries can be used to reclassify specific lines of a source document by, for example, providing SCOA for specific lines in the source document to be reclassified. Adjustment journal entries may also be used to define or reclassify distributions in the lines of a source document by, for example, providing multiple SCOA and amounts for one side of the transaction for specific lines to allocate amounts over multiple accounts.

Reclassifying and/or distributing a source document or specific lines in a source document will result in a single accounting entry for each adjustment journal entry in a period for a company. At times, multiple adjustment journal entries may be generated if the adjustment journal entry is to reclassify or distribute an accounting entry over different periods as may be the case when, for example, executing a revenue recognition event.

An exception notification may be generated if the adjustment journal entry attempts to reclassify or distribute a finalized source document within a closed period if the reclassification/distribution is material. For example, a supplier invoice can be reclassified in a subsequent period up until the invoice is paid per corporate policy.

Manual journal entries are sometimes used to, for example, enter a one-time charge to an accounting entry, enter a recurring charge, enter a manual accrual, enter a manual allocation, and/or enter an automated accrual. An automatic accrual may be used to reference a series of source documents identified through an accrual analysis, but does not reference finalized source documents or amounts. Manual journal entries may also be used to enter automated allocations. Automatic allocations may reference a series of source documents identified through the allocation analysis, but does not reference finalized source documents or amounts.

Sub-ledgers provide a logical grouping of source documents related to a specific accounting activity defined by source document within the general ledger. The source documents within a subledger are be grouped by transaction type, subtype, and, in some instances, line type which drives their accounting rules. Exemplary types of sub-ledgers may relate to one or more categories of documents, including, but not limited to AP, AR, shipments, receiving, inventory transactions, invoices, and/or assets. In some cases, sub-ledgers may be divided into more granular categories by, for example, item class or other accounting segment driver. All source documents belong to a sub-ledger and are governed by their sub-ledger cutoff date for inclusion in a period.

Sub-ledgers are closed as of a sub-ledger cutoff date that closes the sub-ledger for further general ledger date assignment by the accounting rules. Additionally, source documents for a particular sub-ledger cannot be included in a period after the sub-ledger cutoff date. Sub-ledger cutoff dates are associated with a date stamp and/or a time stamp. Source documents that are finalized after the sub-ledger cutoff is assigned a general ledger date in the next period.

The sub-ledger cutoff date may be configured to be as late as the period cutoff date. A sub-ledger cutoff is typically before the period cutoff date, but cannot be after. Journal entries are not managed by the sub-ledger cutoff dates since these are managed by accounting. Instead, journal entries are governed by a period cutoff date.

The flow of source documents into the general ledger for a period is managed by the sub-ledger cutoff date. The general ledger is open to all source documents of the same sub-ledger type before the sub-ledger cutoff date (i.e., finalization date<sub-ledger cutoff date) and closed for all source documents finalized following the sub-ledger cutoff date (i.e., sub-ledger cutoff date < or = finalization date puts the source document into the general ledger in the next period). In instances where the sub-ledger date is different from the period close date, the sub-ledger can effectively be closed and reopened at any time before the period close by adjusting the sub-ledger cutoff date. By default, a sub-ledger's cutoff may be set to be the period end date. A user may also configure it for another date. For example, a convention may be set where the creation date is used as the transaction date and sub-ledger cutoff date is set to be the same as the period end date. The sub-ledger close process can be managed until the period is closed. This is different from the traditional process of managing the flow of source documents into a sub-ledger via a sub-ledger close process. As with the sub-ledgers, the flow of journal entries into the period is managed by a period cutoff date. The period is open to any journal entries finalized up to the period cutoff date. Any journal entries finalized as of or after the period cutoff generate an exception.

In some embodiments, sub-ledgers and periods may have a status, such as future, open, closed or permanently closed. A future status means a particular period is not yet open to accounting entries, source documents, and/or journal entries and any accounting entries, source documents, and/or journal entries with a transaction date occurring in a future sub-ledger or period are flagged with a warning. An open status means the period is currently open to entry of accounting entries from new source documents and/or journal entries that are finalized before the cutoff date/time will and are required to generate an accounting entry in the period. A closed status means the sub-ledger or period has been successfully been validated as closed and all accounting entry generation is complete for a particular sub-ledger or period. No more changes to accounting entries can occur and all values are final for the period. In some embodiments, a closed period or sub-ledger can be reopened and the accounting entries may be regenerated, but no source documents may flow into the sub-ledger or period unless the sub-ledger or period cutoff is changed (in or out) for that period. Reopening a sub-ledger or period without moving the cutoff may be done to allow for a change to an accounting rule or accounting reference data to change the accounting. A sub-ledger or period may be permanently closed, in which case the period cannot be reopened and is permanently locked and protected by the system.

Accounting entry generation may be validated before a sub-ledger or the period can be closed. Validation may confirm that for all source documents finalized before their respective sub-ledger cutoff date and journal entries are finalized before the period close date. The validation process checks to see whether accounting entries are associated with exceptions or are associated with other problems. The validation process further acts to ensure accounting entries in the period match their respective source document or journal entry. For example, data produced from the accounting entry generation process including transaction date, finalization date, finalized state, accounting entry lines generated, segment objects and segment object value, cost information, and any other data values captured for inclusion in the accounting entries matches the corresponding source documents.

Sub-ledgers are each validated separately as part of the close process to capture and compare all data values referenced and included in the accounting entries by the accounting rules. Once validation is complete, the sub-ledger or period is closed. Once the period is closed, the accounting entries are permanent—they cannot be changed and the accounting entries triggers enforce that the accounting entries are immutable. The source documents and journal entries are permanent as well. The sub-ledger cutoff dates for a period are critical information as well and are locked down once the period is closed. However, the accounting rules and related information (standard costs, item class, etc.) can be modified—this has no impact on the general ledger results since all accounting entry information is generated and captured. After sub-ledger close, the accounting entries are never regenerated. After period close the journal entries are never regenerated. If the sub-ledger or period is reopened, the sub-ledger or period must be revalidated as part of a reclose process.

The methods and systems described herein may generate a one or more accounting reports and/or dashboards, which may act to provide a summary of accounting information relating to 1) the source documents and journal entries that are free of exceptions and posted to the general ledger, 2) the categories of exceptions for finalized source documents and journal entries, 3) unfinalized source documents and journal entries, and 4) standard financial and audit reports for accounting validation and audit. For example, a trial balance may be generated in real time from reporting on the active accounting entries (i.e., accounting entries that have no exceptions). Trial balances may be available by sub-ledger, again through reporting. Dashboards (i.e., a set of reports) may be available to compare and tie out all operational documents and activity to the aged trial balance. The trial balance report may also show exceptions and results from other financial reports.

The systems and methods described herein do not use or require either an accounted flag or other indication of posting on the source document as commonly used in other accounting systems. No writes are required back to the source document records in the process of generating accounting entries in the general ledger.

The algorithms and processes presented herein are not inherently related to any particular computer system, processor or other apparatus. Various electronic computing apparatus, along with, where necessary, suitable computer programs that instantiate processes in accordance with the teachings herein, may be used. For example, any of the present methods can be implemented in hard-wired circuitry, by appropriate programming of a computer processor or processors, or any combination of hardware and software may be used to carry out the methods discussed below. Of course, the invention can be practiced with computer system configurations other than those particularly described below, including systems that comprise hand-held devices, multiprocessor systems, microprocessor-based electronic devices, digital signal processor-based devices, networked computer systems, minicomputers, mainframe computers, personal computers, and the like, and it should be recognized that these examples presented herein are used merely for purposes of illustration. The invention can also be practiced in distributed computing environments where tasks are performed by computer processing devices that are remote to one another, either physically and/or logically, and are linked through one or more communications networks.

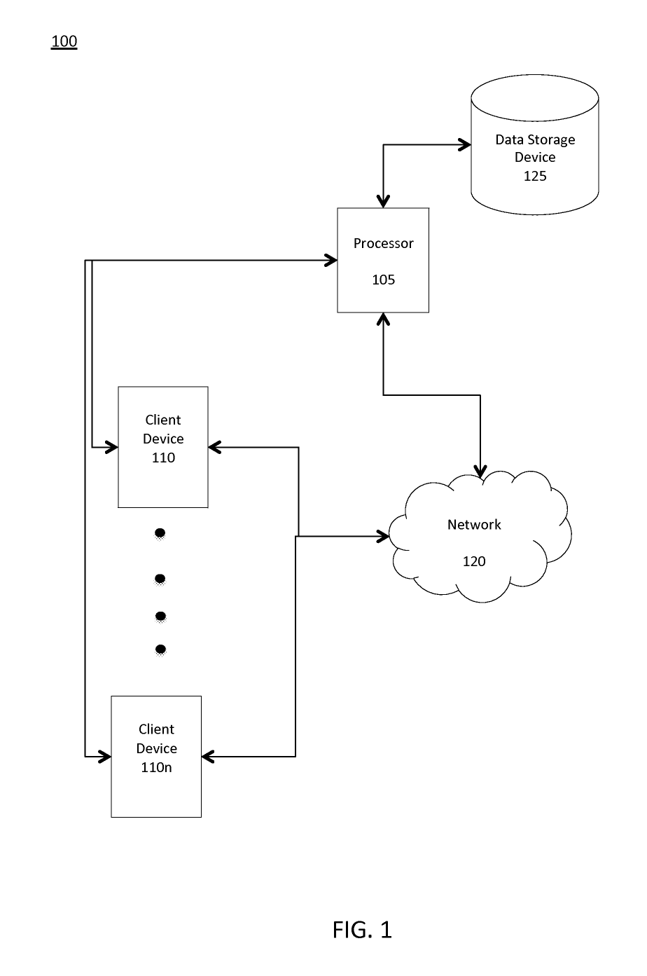

FIG. 1 is a block diagram depicting an exemplary system 100 in which one or more of the methods/processes described herein may be executed. Communication between the components of system 100 may be facilitated by network 120 and/or hardwire connection. System 100 includes a data storage device 125 for the storage of data, such as source documents, rules, instructions for execution by a processor 105, calculation results, sub-ledger information, and/or general ledger information. The source documents stored in data storage device 125 may be accessed by processor 105, which may execute one or more of the processes described herein to, for example, select a sub-ledger, from a plurality of sub-ledgers, into which source data is added responsively to one or more characteristics of the source data, each of the sub-ledgers including a different subset of information included in a general ledger, update the general ledger with the sub-ledger information and provide the updated general ledger to a user of the computer system via one or more client devices 110a-110n.

The following is a discussion of execution of one or more processes described herein for various scenarios, wherein the following abbreviations are used:

Period Start->“PS”

Transaction Date->“TD”

Finalized Date->“FD”

Sub-ledger Close Date->“SLC

Period End Date->“PE”

General ledger->“GL”

GL Close Date->“GLC”

GL Date->“GLD”

Accounting entry->“AE”

Journal entry->“JE”

In general, the following rules and conditions apply to the following scenarios:
1. If FD<SLC & TD<SLC date, the GL date is the TD.
2. If the FD>PE date & TD<SLC, the GL date is the FD.
3. If FD<SLC & TD>SLC date, but <PE date, the GL date is in the period 2 PS date.

(Accrual Period 1)
4. If TD<SLC & FD>SLC date, but <PE date, the GL date is in the period 2 PS date. (Accrual Period 1)
5. If TD>SLC, but <PE date & FD>SLC date & >PE date, the GL date is the FD. (Accrual Period 1)
6. If FD>SLC, but <PE date & TD>SLC date & >PE date, the GL date is the TD. (No Accrual Period 1)
7. Accruals, the GL date is always equal to the PE date
8. Accruals Reversals, the GL date is always equal to the period 2 PS date.

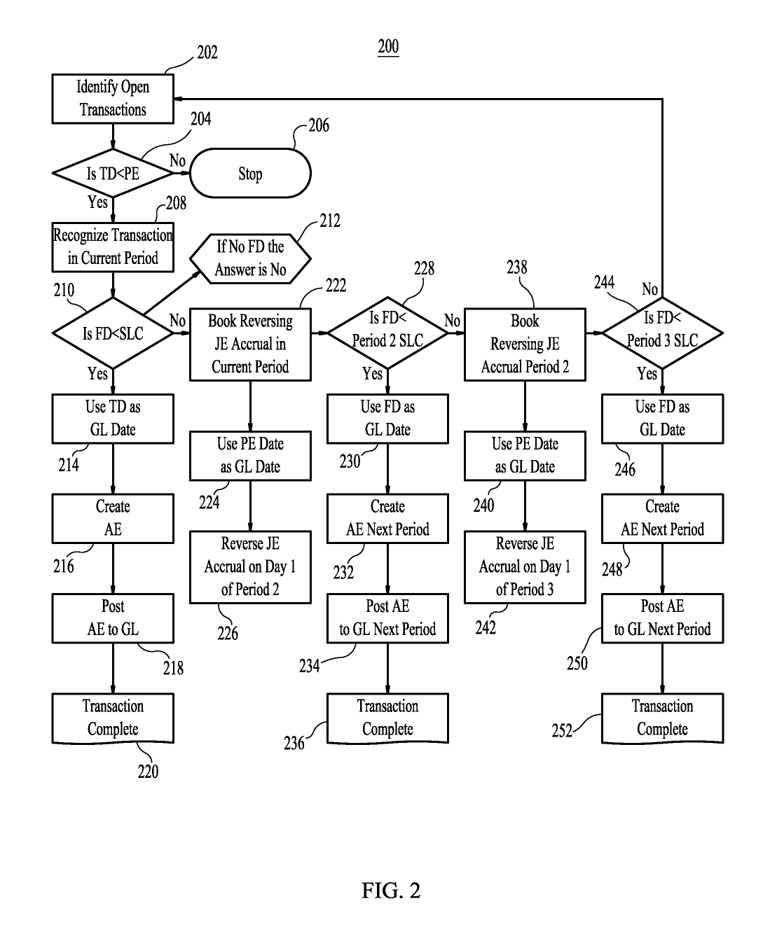

FIG. 2 is a flow chart indicating an exemplary process 200 for generating an accounting entry and posting it to a general ledger in accordance with exemplary circumstances as defined by Scenarios 1, 2, 3, 5, 7, 8, and 9 as discussed in further detail below. Process 200 may be executed by a computer system, such as computer system 100.

The following chart illustrates a timeline of events for Scenario 1:

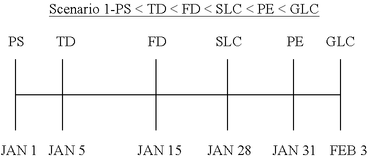

In Scenario 1, a transaction date (TD) for an open transaction is prior to a finalization date (FD) for the transaction and/or a source document associated with the open transaction and also prior to a sub-ledger close date (SLC) for a sub-ledger associated with the open transaction. In Scenario 1, the TD and the FD occur in the same general ledger period and before the SLC date. The transaction should be recognized in the same period as the period in which the economic event happens (this period is also called a “current period”). The transaction will be booked through a system generated AE and pushed and/or posted to the GL in the same period.

Since the FD is before the SLC, the computer system will generate AEs to complete the transaction and post them all in the same period. No JE accrual entries are needed. Since the FD is less than the SLC, the GL Date the same as the TD, which will be the date that the system will post the AE to the GL.

Turning now to FIG. 2, in step 202, open transactions are identified. Then, it is determined whether a transaction date (TD) for an identified open transaction is prior to a period end date (PE) [step 204]. When the TD is after the PE, process 200 stops [step 206]. The open transaction will be recognized [step 208] when the TD is prior the PE date. Next, it is determined whether the FD is prior to the SLC date [step 210]. In circumstances where the open transaction does not have a finalization date, the lack of an FD will be interpreted as the FD being after the SLC [step 212]. When the FD is prior to the SLC date, the TD is used as the general ledger (GL) date [step 214] for creation of the accounting entry (AE) [step 216]. The AE is then posted to the general ledger [step 218] and the transaction is completed [step 220]. Completion of a transaction may include closing, or otherwise marking, the transaction, so that it will no longer be identified as “open.”

The following chart illustrates the timeline of events for an exemplary Scenario 2:

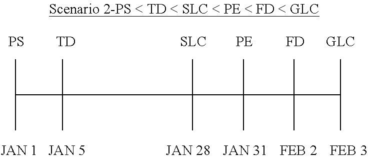

In Scenario 2, a transaction date for a transaction that occurs within a current period and is prior to a sub-ledger close date, which is prior to a period end date (PE), which is prior to a finalized date (FD). Scenario 2 may be represented in symbolic form as TD<SLC<PE<FD. Of note in Scenario 2 is that the FD occurs after both the SLC and the PE. Thus, the transaction may be recognized in the current period, but the system won't generate an AE, triggered by the FD, until the next period has been opened. To accomplish the recognition, a reversing accrual JE needs to be booked in, or posted to, the current period before the GL close date (GLC), which will be reversed out on the first day of the next period (period 2).

Turning now to FIG. 2, the steps 202, 204, 208, are executed and, in step 210, it is determined that the FD is greater than, or after, the SLC date. A reversing JE accrual entry is then created before GLC date for the current period [step 222], wherein the PE date is used for the accrual GL date [step 224]. Then, in the next period (period 2), the JE accrual may be reversed on the first day of period 2 [step 226] and steps 202, 204, 208-218 may be repeated.

A timeline of events for a third exemplary scenario, Scenario 3, is depicted in the chart below:

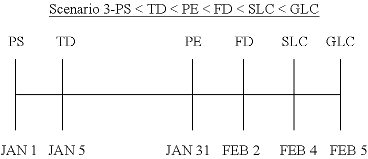

In Scenario 3, PS<TD<PE<FD<SLC<GLC and the TD occurs during the open, current period, but the FD is after the PE date and before the SLC. Thus, the transaction will be recognized in the current period and the transaction will be booked through a system generated AE and pushed to the GL in the same, current period.

Since the FD is before the SLC, AEs may be generated so that the transaction may be completed within the current period. No JE entries are needed to accomplish this. The TD may then be used as the GL Date, which may correspond to the date on which the AE posts to the GL.

Turning now to FIG. 2, to execute process 200 in accordance with Scenario 3, steps 202, 204, 208, 210, and 214-220 may be executed.

A timeline of events for a fourth exemplary scenario, Scenario 4, is depicted in the chart below:

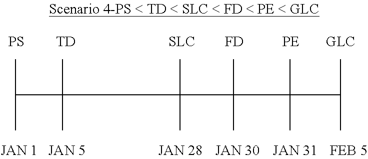

In Scenario 4, TD<SLC<FD<PE and the TD is during the current period. However, the FD is after the SLC and before the PE. The transaction will be recognized in the current period, but an AE won't be generated until the next period has been opened. A reversing accrual JE may be booked in the current period before the GL close date (GLC), which will be reversed out on the first day of the next period. Additionally, since the FD date is after the SLC but before the PE, the user will not want the system to post to the GL in period 2 using a period 1 date. In this case, the system will post the GL using the period 2 PS date as the GL date.

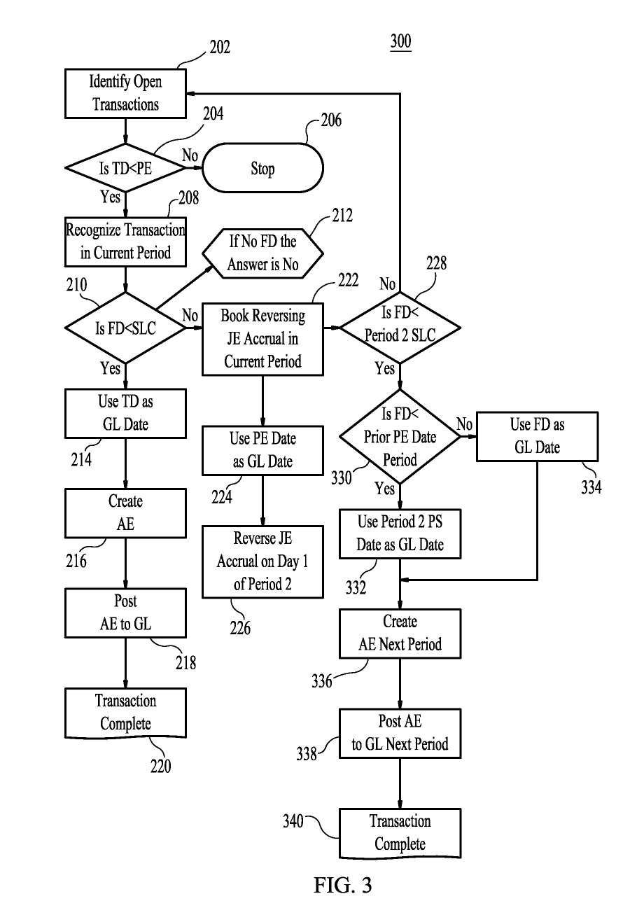

Turning now to FIG. 3, an exemplary process 300 for generating an accounting entry and posting it to a general ledger in accordance with exemplary circumstances as defined by Scenario 4 is provided. Process 300 may be executed by any of the systems or system components described herein, such as system 100.

Initially, steps 202, 204, and 208 are performed. In step 210, it is determined that the FD is not prior to the SLC date. A reversing JE accrual is then created before the GLC date for the current period [step 222]. The PD date is used for the accrual GL date [step 224].

Then, in the next period (period 2), the JE accrual may be reversed on, for example, the first day of period 2 [step 226]. Then, steps 202 and 204 may be performed and, responsive to a determination that the TD is prior to the PE date, the transaction may be recognized [step 208]. It may then be determined whether the FD is prior to the SLC date for the next period [step 228]. Then, it may be determined whether the FD is less than the PE end date of the prior period [step 330] and, if not, the FD may be used as the GL date [step 334]. If the FD is less than the PE date of the prior period, then an AE may be created for entry into the next period [step 336] using the PS date for the next period as the GL date for the transaction [step 332]. The AE may then be posted to the GL in the next period [step 338] and the transaction may be completed [step 340].

A timeline of events for a fifth exemplary scenario, Scenario 5, is depicted in the chart below:

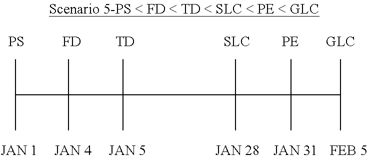

In Scenario 5, FD<TD<SLC<PE and the TD is during the current period. The FD is before the TD, the SLC date, and the PE date and the transaction will be recognized in the current period. The transaction may be booked through a system generated AE and posted to the GL in the same, current period.

Since the FD is before the SLC, the system will generate AEs to complete the transaction all in the same period. No JE entries are needed. The system will use the TD as the GL Date, which will be the date that will post to the GL. Turning now to FIG. 2, which illustrates how process 200 may be executed for Scenario 5, at first, an open transaction may be identified [step 202]. It may then be determined that the TD is prior to the PE date [step 204] and the transaction may be recognized [step 208]. When the FD is prior to the SLC date [step 210], an AE may be created [step 216] using the TD as the GL date [step 214]. The created AE may then be posted to the GL [step 218] and the transaction may be complete [step 220].

A timeline for a sixth exemplary scenario, Scenario 6, is depicted in the chart below:

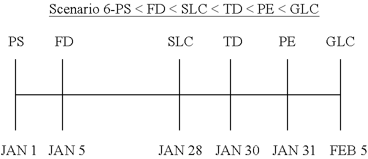

In Scenario 6, FD<SLC<TD<PE and the TD is during the period. The FD is before the SLC date, the TD, and the PE date. The transaction will be recognized in the current period. However, although the FD is less than the SLC date, an AE won't be generated in the current because the TD is after the SLC date. Additionally, a reversing accrual JE will be booked in the current period before the GL close date (GLC), which will be reversed out on the first day of the next period. In next period, the system will see that both the FD and TD are less than the SLC and will generate an AE to process the transaction.

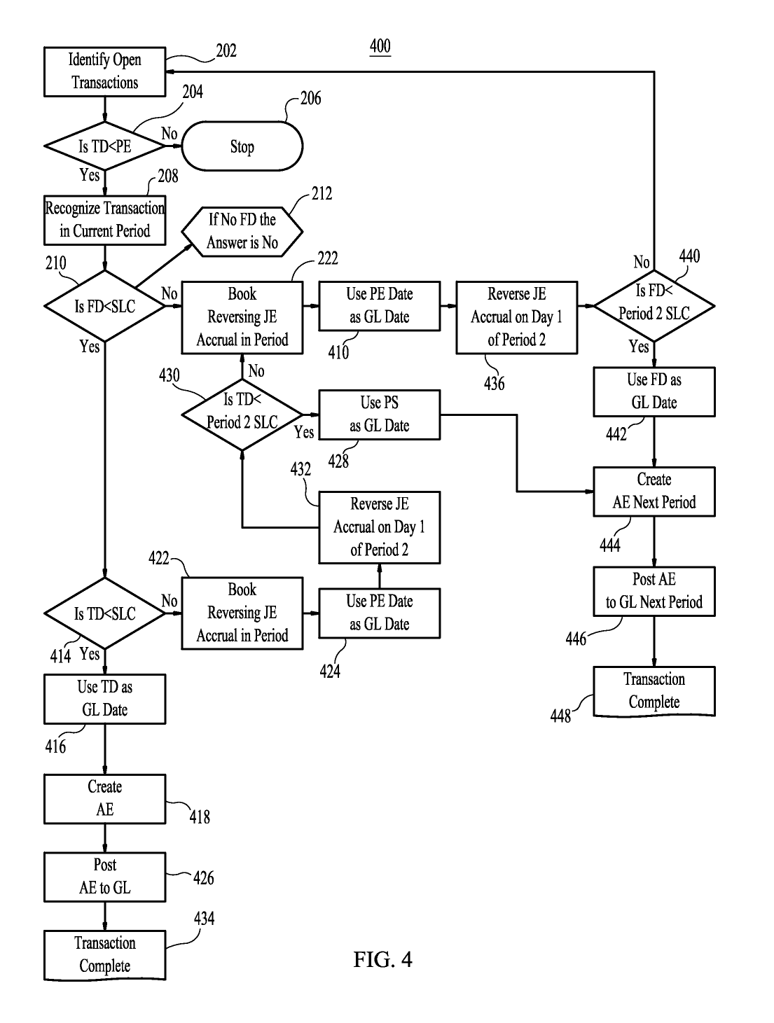

Turning now to FIG. 4, an exemplary process 400 for generating an accounting entry and posting it to a general ledger in accordance with exemplary circumstances as defined by Scenario 6 is provided. Process 400 may be executed by any of the systems or system components described herein, such as system 100.

Initially, an open transaction may be identified [step 202]. It may then be determined that the TD is prior to the PE date [step 204] and the transaction may be recognized [step 208]. When the FD is prior to the SLC date [step 210], it may then be determined whether the TD occurs prior to the SLC [step 414]. When the TD date occurs after the SLC date, a reversing JE accrual may be created for and booked to the current period [step 422]. The PE date of the created JE accrual may be the same as the GL date [step 424].

When the next period (period 2) begins, the JE accrual may be reversed on the first day [step 432]. It may then be determined whether the TD is prior to the SLC of period 2 [step 430]. When the TD is prior to the SLC of period 2, an AE may be generated [step 444] using the PS as the GL date [step 428]. The AE may then be posted the next period [step 446] and the transaction may be complete [step 448].

If the TD is greater, or after, the SLC for the period [step 430], then a reversing JE accrual entry may be booked to the current period [step 222] using the PE date as the GL date [step 410]. Then, the JE accrual may be reversed on day 1 of period 2 [step 436] and it may be determined if the FD of the transaction is prior to the SLC of period 2 [step 440]. If not, then process 400 may return to step 202. If the FD is prior to the SLC of period 2, then an AE for the next period may be created [step 444] using the FD as the GL date for the AE [step 442]. The AE will then post to the next GL period [step 446] and the transaction will be complete [step 448].

When the FD is after the SLC [step 210], then a reversing JE accrual entry may be booked to the current period [step 222] using the PE date as the GL date [step 410]. Then, the JE accrual may be reversed on day 1 of period 2 [step 436] and it may be determined if the FD of the transaction is prior to the SLC of period 2 [step 440]. If not, then process 400 may return to step 202. If the FD is prior to the SLC of period 2, then an AE for the next period may be created [step 444] using the FD as the GL date for the AE [step 442]. The AE will then post to the next GL period [step 446] and the transaction will be complete [step 448].

When the TD date is after the SLC [step 414], then an AE may be created [step 418] using the TD date as the GL date [step 416]. The AE may then post to the GL [step 426] and the transaction is completed [step 434].

A timeline of events for a seventh exemplary scenario, Scenario 7, is depicted in the chart below:

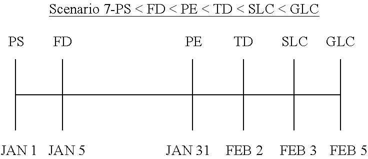

In Scenario 7, FD<PE<TD<SLC and the TD is after the PE date. In this case, the transaction does not need to be recognized until period 2. Thus, nothing needs to be booked in the current period.

Initially, the transaction is identified as open [step 202] and it is determined whether the TD is less than PE date [step 204]. Because the TD is not less then the PE date, the transaction is not recognized in period 1 [step 206]. Then, in the next period, period 2, the transaction is identified as open [step 202] and it is determined that the TD is less than PE date [step 204]. The transaction will be recognized transaction in current period (i.e., period 2) [step 208]. Next, it may be determined whether the FD is less than SLC date [step 210] and, if so, the system creates an AE [step 216] using the PE date for the GL Date [step 214] and the transaction may be completed [step 220].

A timeline for an eighth exemplary scenario, Scenario 8, is depicted in the chart below:

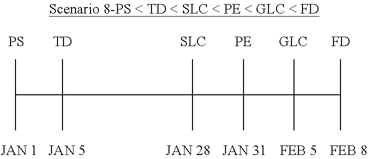

In Scenario 8, TD<SLC<PE<GLC<FD and the TD occurs during the current period, but the FD is after the GLC date when the period is permanently closed. The transaction will be recognized in the current period, but an AE won't be generated (the generation of the AE would be triggered by the FD) until the next period (period 2) has been opened. A reversing accrual JE will be booked in the current period before the GL close date (GLC), which will be reversed out on the first day of the next period. Additionally, the transaction does not have an FD. In this case, an absent FD is equal to the FD being greater than the SLC and should return a no response to the determination of step 212.

Turning now to FIG. 2, which illustrates how process 200 may be executed for Scenario 8, at first, an open transaction may be identified [step 202]. It may then be determined that the TD is prior to the PE date [step 204] and the transaction may be recognized [step 208]. It may then be determined if the FD is prior to the SLC [step 210] and, if the FD is missing from the transaction, and then process 200 proceeds as though the FD is not prior to the SLC [step 212]. A reversing JE accrual may then be created before GLC date for the current period [step 222] using the PE Date as the accrual GL Date [step 224]. Then, the JE accrual may be reversed on the first day in the next period (period 2) [step 226] and the transaction may be identified as open [step 202]. It is then determined that the TD is less than PE date [step 204]. The transaction may be recognized in the current period [step 208] and then it may be determined that the FD is less than SLC date [step 210]. An AE may then be generated [step 216] using the TD as the GL date [step 214]. The AE may be posted to the GL [step 218] and the transaction may be completed [step 220].

A timeline for an ninth exemplary scenario, Scenario 9, is depicted in the chart below:

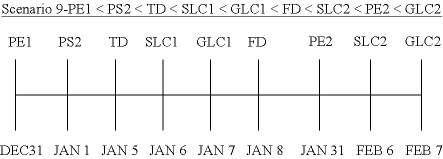

In Scenario 9, PE1<TD<SLC1<GLC1<FD. Scenario 9 is similar to Scenario 7, where the full logic of the workflow will be run in each month with different results. The TD will be in period 2, but before the SLC1 and GLC1 dates. The FD will be before SLC2, so the TD will be the GL date. In this case, the transaction does not need to be recognized until period 2. Nothing needs to be booked in the current period (period 1).

In period 1, the TD is after the PET date, the determination of step 204 will be no and, consequently, the transaction will not be recognized in period 1. In period 2, the determination of step 204 will be yes and an AE will be generated and the transaction will be completed. No JE accrual entries are needed.

Turning now to FIG. 2, which illustrates how process 200 may be executed for Scenario 9, at first, an open transaction may be identified [step 202]. It may then be determined that the TD is after to the PE date [step 204] and, as a consequence, the transaction may not be recognized within the current period. Then, in the next period (period 2), the open transaction may be identified [step 202] and it may then be determined that the TD is prior to the PE date [step 204] and, consequently, the transaction may be recognized in period 2 [step 208]. Then, it may be determined that the FD is prior to than SLC date [step 210] and an AE may be created [step 216] using the TD for the GL Date [step 214]. The AE may then be posted to the GL [step 218] and the transaction may be completed.

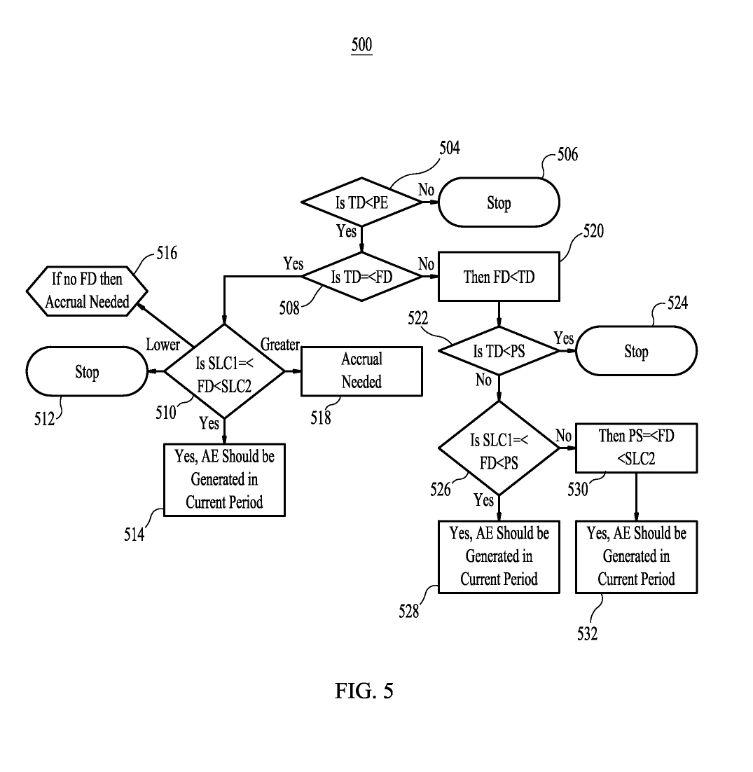

FIG. 5 illustrates a flow chart for an exemplary process 500 of generating an accounting entry (AE) in a current period and determining when to enter an accrual into the general ledger (GL). Process 500 may be executed by, for example, system 100.

Initially, it may be determined whether a transaction date (TD) for a given transaction is prior to the current period's end date (PE) [step 504]. When the TD is after the PE, process 500 stops [step 506]. Responsive to a determination that the TD is prior to the PE [step 504], it may further be determined whether the TD is equal, or prior, to the finalized date (FD) [step 508]. When the TD is equal, or prior, to the FD, it may be further determined whether a sub-ledger close date for a first period (SLC1) is on the same day or prior to the FD and whether the FD is prior to a sub-ledger close date for a second period (SLC2) [step 510] and, if so, an AE should be generated within the current period [Step 514]. When the FD is greater than, or after, SLC2 an accrual may be needed [step 518]. When the FD is lower then, or prior to, SLC2 and SLC1, or when there is no FD associated with the transaction [step 516], process 500 may stop [step 512].

In circumstances where it is determined that the TD is not on the same day were prior to the FD [step 508], then it is determined that the FD is after the TD [step 520]. Next, it is determined whether the TD is prior to the PS and, if so, process 500 may stop [step 524]. When it is determined that the TD is after the PS, it may be further determined whether the SLC1 is on the same day or prior to the FD and whether the FD is prior to the PS [step 526] and, if so, it may be determined that an AE should be generated and/or booked in the current period [step 528]. When it is determined that the SLC1 is after the FD and/or the FD is after PS, it may be determined that the PS is on the same day or after the FD and the FD is before the SLC2 and, if so, an AE should be generated in the current period [step 532].

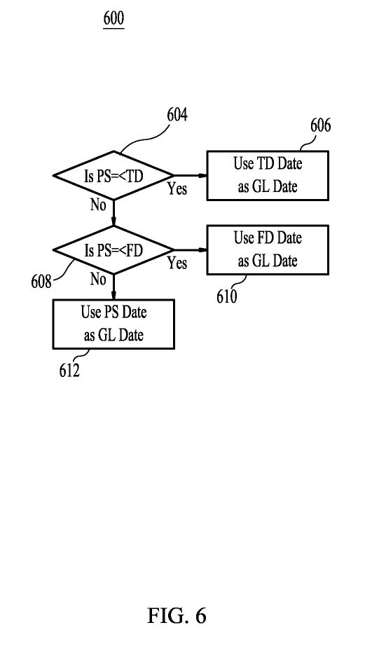

FIG. 6 is a flow chart depicting a process 600 for determining a GL date to associate with a transaction. Process 600 may be executed by, for example, system 100.

Initially, in step 604, it may be determined whether the period start date (PS) for a transaction is on the same day, or before a transaction date (TD) and, if so, the TD date is the GL date [step 606]. If not, then it is further determined whether the period start date (PS) is on the same day, or before a final date (FD) [step 608]. When the PS is on the same day, or before the FD, then the FD date should be used as the GL date [step 610] and, if not the PD date should be used as the GL date [step 612].

What is claimed is:

1. A method executed computer system, the method comprising:
receiving source data at a computer system, the source data including information regarding a financial transaction and being associated with one or more characteristics;
selecting a sub-ledger, from a plurality of sub-ledgers, into which the source data is added responsively to one or more characteristics of the source data, each of the sub-ledgers including a different subset of information included in a general ledger;
updating the general ledger with the sub-ledger information; and
providing the updated general ledger to a user of the computer system.

2. The method of claim 1, further comprising:
validating the general ledger on, or following, a closing date of a time period associated with the general ledger; and
finalizing the general ledger such that the information included in the general ledger pertaining to the time period cannot be changed.

3. The method of claim 2, wherein the source data is associated with a finalization date, the sub-ledger is associated with a cutoff date, and the validation is performed using source data with a finalization date occurring on, or after, the general ledger closing date and sub-ledger information with a cutoff date occurring on, or after, the general ledger closing date.

4. The method of claim 1, wherein the general ledger is dynamically updated prior to the closing date of the general ledger.

5. The method of claim 1, wherein the source data includes financial information about a projected financial transaction.

6. The method of claim 1, wherein the general ledger is compliant with governmental regulations.

7. The method of claim 1, comprising:
receiving an instruction to delete the source data from the sub-ledger;
updating the sub-ledger by deleting the source data from the sub-ledger responsively to the received instruction; and
updating the general ledger with the updated sub-ledger.

8. The method of claim 1, wherein the source data is finalized, the method comprising:
receiving an instruction to adjust the source data; and
generating an adjustment entry for the at least one of the sub-ledger and the general ledger responsively to the received instruction.

9. The method of claim 1, wherein the general ledger is dynamically updated as the source data is received.

10. The method of claim 1, wherein the source data is received from a plurality of sources.

11. A method executed by a computer system, the method comprising:
identifying an open transaction;
determining whether a transaction date of the open transaction is prior to a period end date for a general ledger;
recognizing the open transaction as being associated with a current period of the general ledger and associating the open transaction with a sub-ledger responsively to a determination that the transaction date is prior to the period end date;
determining whether a finalization date of the open transaction is prior to a sub-ledger closing date;
creating an accounting entry for the open transaction, the accounting entry including the transaction date as a date within the general ledger responsively to a determination that the finalization date of the open transaction is prior to a sub-ledger closing date;
posting the accounting entry to the general ledger; and
providing the general ledger to a user of the computer system.

12. The method of claim 12, further comprising:
generating a reversing journal entry accrual in the current period using the period end date as the general ledger date responsively to a determination that a final date for an open transaction is after a sub-ledger closing date; and
posting the reversing journal entry accrual to the general ledger in the current period.

13. The method of claim 13, further comprising:
reversing the journal entry accrual on the first day of the next period.

14. The method of claim 13, further comprising:
creating another accounting entry using a finalization date of the open transaction as a general ledger date responsively to a determination that the finalization date for the open transaction is prior to a sub-ledger closing date for the second period; and
posting the other accounting entry to the general ledger in the second period.

15. The method of claim 12, further comprising:
generating a reversing journal entry accrual in the current period using the period end date as the general ledger date responsively to a determination that a transaction date for the transaction is after the sub-ledger closing date; and
posting the reversing journal entry accrual to the general ledger in the current period.
